(19) United States
(12) Patent Application Publication
(10) Pub. No.: US 2025/0251509 A1
(43) Pub. Date: Aug. 7, 2025

(54) DETERMINING DISTANCE BETWEEN A REFERENCE NODE AND A MEASURED NODE OF A MULTIDROP NETWORK

(71) Applicant: Microchip Technology Incorporated, Chandler, AZ (US)

(72) Inventors: Venkatraman Iyer, Austin, TX (US); Hongming An, San Diego, CA (US); Hussein El-Shafie, Cork (IE)

(21) Appl. No.: 19/043,288

(22) Filed: Jan. 31, 2025

Related U.S. Application Data
(60) Provisional application No. 63/548,565, filed on Feb. 1, 2024.

(51) Int. Cl. G01S 13/76; H04L 43/0864; H04W 64/00

(52) U.S. Cl. CPC G01S 13/765; H04L 43/0864; H04W 64/00

(57) ABSTRACT

A method may include: generating round-trip pulses at one or more nodes of a multidrop network, respective ones of the round-trip pulses selectively traversing one or more of: internal circuitry of the one or more nodes, or a physical medium between a first node and a second node of the one or more nodes; determining a total delay and an internal delay of the one or more nodes at least partially based on a measurement window error and measured round trips of the round-trip pulses within a predetermined measurement window; and determining a distance between the first node and second node at least partially based on the measured round trips of the round-trip pulses and the internal delay of at least one of the first node or the second node.

### CROSS-REFERENCE TO RELATED APPLICATIONS

This application claims the benefit under 35 U.S.C. § 119(e) of U.S. Provisional Patent Application Ser. No. 63/548,565, filed Feb. 1, 2024, the disclosure of which is hereby incorporated herein in its entirety by this reference.

### BACKGROUND

Network topology discovery is the process of learning information about the topology (e.g., distances, without limitation) of a network.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram of an apparatus that determines internal delay, in accordance with one or more examples.

FIG. 2 is a schematic diagram depicting a system to measure distance between an RN and an MN, in accordance with one or more examples.

FIG. 3 is a signal timing diagram illustrating a method for determining round-trip time, in accordance with one or more examples

FIG. 4 is a diagram depicting changes to the TD control register and Topology Discovery Register of the OA's TC14 specification, in accordance with one or more examples.

FIG. 5 illustrates an example process to determine distance between a first node and a second node that are both on a multidrop network/Ethernet segment, in accordance with one or more examples.

FIG. 6 illustrates an example process to measure round trips of round-trip pulses when the predetermined, fixed measurement window is a fixed number of round trips (e.g., expressed as a fixed pulse count), in accordance with one or more examples.

FIG. 7 illustrates an example process to enhance measurement resolution by counting both rising and falling edges of a clock signal during a fixed number of round trips, in accordance with one or more examples.

FIG. 8 illustrates an example process to detect and handle partial or fractional round trips of round-trip pulses, in accordance with one or more examples.

FIG. 9 illustrates an example process to detect and handle partial or fractional round trips by round-trip pulses, in accordance with one or more examples.

FIG. 10 illustrates an example process to measure round trips of round-trip pulses when the predetermined, fixed measurement window is a fixed time duration, in accordance with one or more examples.

FIG. 11 is a block diagram of a circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” on, “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

10BASE-T1S is a network technology specified in IEEE 802.3cg™. 802.3cg specifies physical layer (PHY) behavior for Physical Layer Collision Avoidance (PLCA) on a multidrop network. A multidrop network is a communication network where multiple devices are connected to and share a single physical medium, such as a twisted-pair or coaxial cable, without limitation. The Open Alliance (OA) Tech Committee (TC) 14 adds other specifications for automotive use of a PHY. For example, OA's TC14 has a specification for topology discovery (TD).

The specification for TD starts with a single pulse sent from a reference node (RN) to a measured node (MN). Upon receipt, the MN transmits a pulse to the RN after a fixed internal delay. Upon receipt, the RN transmits a further pulse to the MN after a fixed internal delay. This completes one round trip (RT). The number of RTs in a predetermined time duration depends on the set time duration, the distance between the MN and RN, and their respective internal delays. With those parameters, the distance between RN and MN (e.g., the length of a cable between RN and MN) may be computed. Internal delays may be computed similarly using a pulse and a pulse echo from a pin that connects the MN or RN to the physical medium (instead of remote node).

The inventors of this disclosure appreciate that a predetermined time duration is not necessarily evenly divisible by the RT time duration (i.e., the predetermination time duration is not necessarily an integer multiple of the RT time duration). The OA's TC14 specification does not account for fractional RTs, and so the last RT may be lost if the time duration ends before the last RT completes. Thus, a measurement based on a count of RTs may be inaccurate by up to about the time duration of an RT.

One or more examples relate, generally, to a method of determining the distance between an MN and an RN (here, distance means length of a physical medium). A time duration to perform a predetermined number of RTs in internal networks (from TX to RX to TX pin) of the MN and the RN are determined. The determined time duration divided by the predetermined number of RTs is the internal delay. A time duration to perform a predetermined number of RTs over the physical medium (MN to RN to MN) is determined. The determined time duration divided by the predetermined number of RTs less the respective internal delays of MN and RN is the time to travel the length of the physical medium.

One or both of an RN and an MN may determine distance. The internal delays of both the MN and RN are used in the distance formula. MNs and RNs may share the internal delay values with each other. By way of non-limiting example, the TC14 specification provides that RNs and MNs may request internal delay values via Ethernet frame exchange. By way of further non-limiting example, when an MN uses pulses to measure its internal delay, the pulse stream is visible to anyone on the bus, including the RN, so the RN and MN may co-ordinate their respective finite state machines (FSMs) so that an RN can measure time between set count of the MN's pulses.

In either case there are 3 stages: RN int delay, MN int delay, RN-MN measured delay. There is a symmetry here—Pulse stream of each stage will be on cable and visible to both nodes. So, each can measure the three (3) times independently. Comparing the two values could provide better resolution in some cases (e.g., when stubs are long, without limitation).

By measuring the duration of a predetermined number of round trips instead of the count of round trips in a fixed duration, the inaccuracy is reduced to a fraction of a clock cycle, which is an improvement over methods that rely on a fixed time duration. Utilizing the above technique, the inaccuracy is limited to a clock period of a clock utilized to determine the time duration for the predetermined number of RTs at the internal network or over the physical medium. Different number of RTs may be utilized at an internal network than over a physical medium as long as the respective numbers are known.

The above technique for determining distance discussed herein may be utilized instead of the existing technique in the OA's TC14 specification. Additionally or alternatively, techniques for determining distance discussed herein may be selectively utilized with the existing technique in OA's TC14 specification.

One or more embodiments relate, generally, to a method of determining the distance between an MN and an RN. Determine a fractional RT time, which is the time duration from the start of the last pulse to the end of the predetermined time duration. The fractional RT time may be measured by a clock which has a suitably high clock rate. The fractional RT time is subtracted from the predetermined time duration and the adjusted predetermine time duration is utilized to determine the distance between the MN and RN.

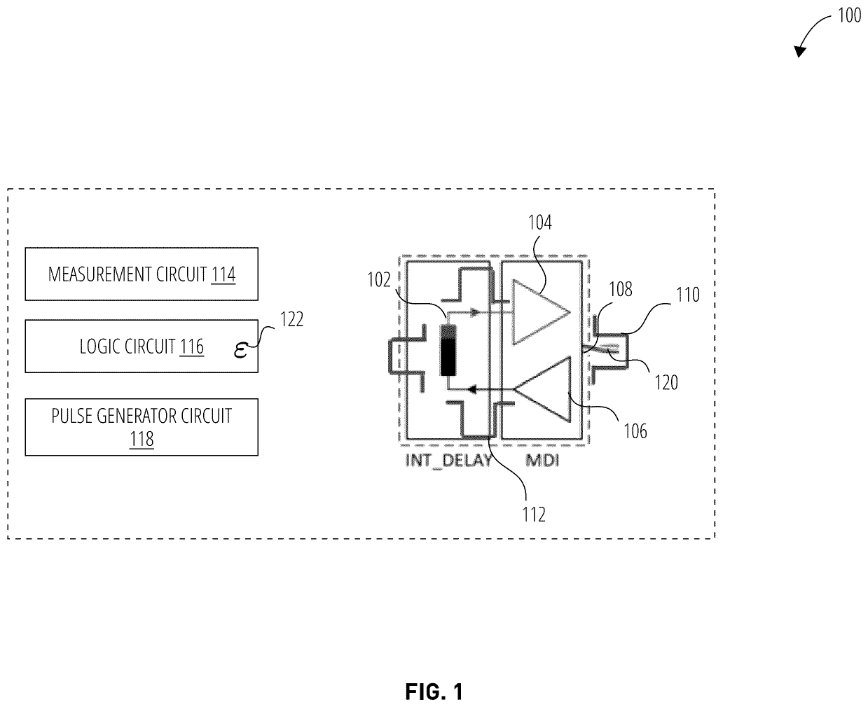

FIG. 1 is a schematic diagram of an apparatus 100 that determines internal delay in accordance with one or more examples. Apparatus 100 may include a physical layer device (PHY) in a topology discovery (TD) mode for determining internal delay. Apparatus 100 may be referred to herein as a “node 100.”

Node 100 includes internal circuit 102, transmitter 104, receiver 106 and connection 108. Node 100 further includes measurement circuit 114, logic circuit 116, and pulse generator circuit 118, operative at least when node 100 is in a topology discovery mode.

Pulse generator circuit 118 is a hardware and/or firmware-driven component that produces (e.g., generates or initiates (e.g., via transmitter 104, without limitation), without limitation) pulses, including without limitation, the round-trip pulses used for measuring delay and distance in a multidrop network, as discussed below. In one or more examples, pulse generator circuit 118 may be responsible for producing pulses at specific intervals or in response to commands from logic circuit 116. In one or more examples, pulse generator circuit 118 creates the signals (“round-trip pulses”) that traverse internal circuit 102 of node 100 and a physical medium (a portion 120 of a physical medium may denoted “physical medium portion 120”) depicted between nodes (connected nodes not depicted), as described below.

Measurement circuit 114 is a hardware and/or firmware-driven component that captures and quantifies measurement data, including information about round trips of round-trip pulses produced by pulse generator circuit 118 within a specified measurement window, as discussed below. Generally speaking, measurement circuit 114 measures how many pulses fit in a predetermined time duration of a measurement window, or how much time elapses for a predetermined number of pulses. As discussed below, measurement circuit 114 may gather information about partial round trips that cross the boundary of a measurement window (if applicable). In one or more examples, measurement circuit 114 may provide measurement data indicative of whether a measured number of round trips should be increased or decreased, or whether the measurement window should be extended or reduced (adjustable measurement window scenario), depending on design, as discussed below.

Logic circuit 116 is a control or processing block—e.g., implemented as digital logic, a microcontroller, or firmware—that analyzes the measurement data it utilizes to determine delay (delay of physical medium, total delay, and internal delay of a node), and measurement window error 122, as discussed below.

When in the topology discovery mode, transmitter 104 sends a pulse 110 and receiver 106 receives a pulse echo 112 that is a reflection of pulse 110 from connection 108. Internal circuit 102 couples receiver 106 to transmitter 104. Pulse echo 112 propagates via internal circuit 102 from receiver 106 to transmitter 104. Leading edges of a pulse are sampled via a local clock (not depicted) and the samples are utilized by an edge detector (not depicted) to detect leading edges of the pulse echo 112 when received at transmitter 104. Upon detection of a leading edge of pulse echo 112, an RT count is updated. Meanwhile, a rising edge timer (or counter) and a falling edge timer (or counter) are continuously incremented by rising and falling edges of a clock, respectively. When the RT count is equal to a predetermined threshold (e.g., a predetermined number of RTs, without limitation) the timers stop, the timer values are averaged (summed and divided by 2), and the average timer value is divided by the predetermined number of RTs is the internal delay of node 100.

In one or more examples, an internal system clock of node 100 is used as the timing source for the timers. In topology discovery, inaccuracy limits the resolution of measured distance. Inaccuracy may be reduced, as a non-limiting example, by half a clock period (if duration is measured on both rising and falling edges of a clock that exhibits 50% duty cycle on average). Resolution scales with clock frequency. Resolution is not a function of internal delay or cable length. The appropriate trade-off between resolution and measurement time is a matter of design choice based on, as a non-limiting example, specific operating conditions.

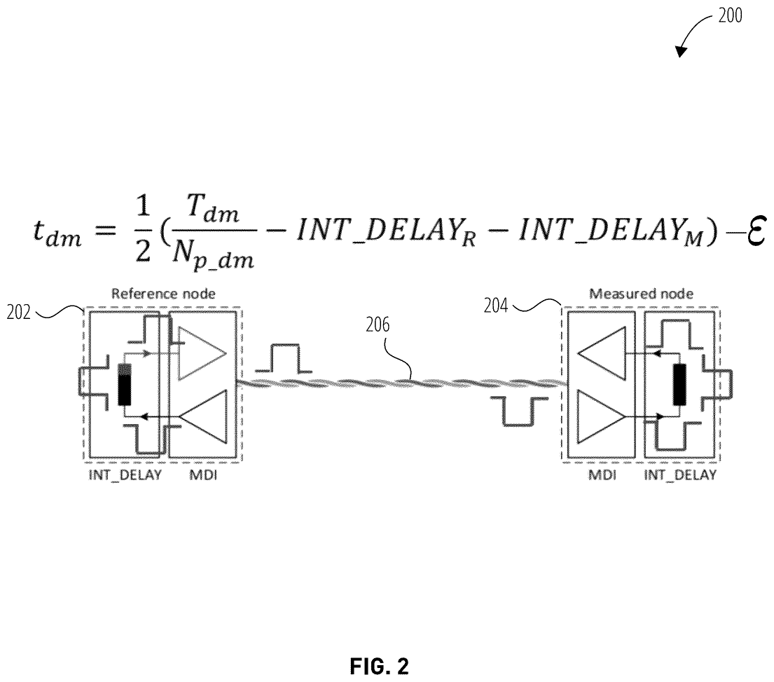

FIG. 2 is a schematic diagram depicting a system 200 to measure distance between an RN and an MN, in accordance with one or more examples.

In one or more examples, respective ones of reference node 202 and measured node 204 may be a node 100.

The respective internal delay of reference node 202 and measured node 204 may be measured—either the node measures its own delay (e.g., with an internal loopback), or another node on the bus measures it by observing that node's pulse activity. In one or more examples, sharing or accessing these internal delay values can happen, as non-limiting examples, by direct frame exchange; here the measured node's or reference node's delay is transmitted to the other node via Ethernet messages or a similar data protocol, or by monitoring pulse streams on the shared medium, since all pulses are visible on the bus. In the later example, the reference node 202 and measured node 204 may coordinate respective finite state machines (FSMs) so one node (e.g., RN) can observe precisely how many pulses (or how much time) the other node (MN) took in its internal loopback. Once both internal delays (MN and RN) are known by the node performing the distance calculation (reference node 202), that node subtracts the sum of these internal delays from the total measured round-trip time, as discussed below. The result corresponds to the time through the physical medium 206.

In a contemplated example, measure with RT count set to 1000. In this example, assume real time to measured time could be off by 0.5 clock period, and asynchronous pulse edge is sampled by either edges of a 25-Megahertz clock.

Error in determined distance is 20/1000 or 20 picoseconds. Error in determined internal delay is 20/1000 or 20 picoseconds. Inaccuracy=20+20+20=60 picoseconds. Thus, distance error of 0.6 centimeter. This is a 20× or more improvement over existing distance measurement technique in the OA TC14 specification.

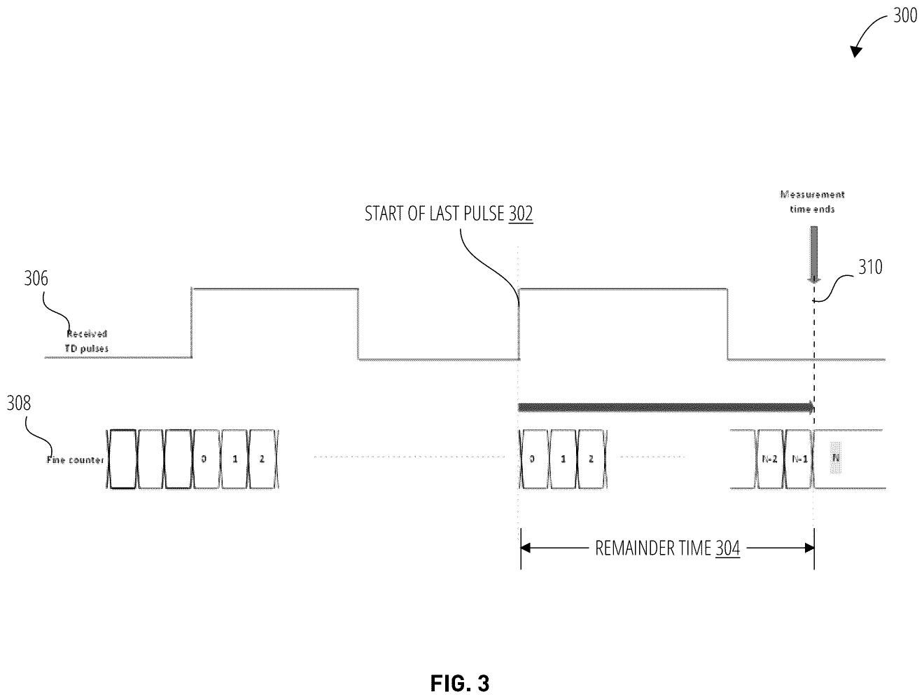

FIG. 3 is a signal timing diagram 300 illustrating a method for determining round-trip time, in accordance with one or more examples. The method incorporates a fine timing counter in the measurement of the total round-trip duration of transmitted pulses, specifically, to capture fractional reminder time, as discussed below. Information about the reminder time and the number of complete round trips (complete round trips may be counted by a coarse or integer counter not depicted by FIG. 3) are used to adjust a predefined measurement time and the adjusted measurement time can be used in distance calculations.

In this example, a first timer (a coarse counter or integer counter) that is not explicitly labeled in FIG. 3 is used to count the number of complete round trips. In this specific, non-limiting example, the first timer counts round-trip pulses (denoted time domain (TD) pulses 306 in FIG. 3s) from leading edge to leading edge of pulses. A second timer 308 (fine counter or fractional counter) operates at a finer resolution (i.e., than the first timer) to measure the remainder time 304, which is a portion of time between the start of last pulse 302 (i.e., leading edge of the last pulse) and the end of the predefined measurement time 310.

By way of contemplated operation, measure for a predefined time duration (e.g., utilize existing technique in Ethernet specification). During the predefined time duration, use a first timer (coarse or integer counter) to measure complete round trips. Use a second timer 308 (a fine or fractional counter of clock cycles) to measure the remainder time 304 from start of last pulse 302 to end of measurement time 310. The remainder time 304 represents the measurement window error, for example, error in the predefined time duration, i.e., the difference between the predefined time duration for a respective RT count and the actual time duration for the respective round-trip count (i.e., the closest full integer count of round-trip times). The remainder time 304 is subtracted from the predefined time duration to determine the adjusted measurement time (which is equal to the total-round trip time of completed round-trip pulses). The adjusted measurement time may be utilized to determine an average round-trip time and/or distance, as discussed herein.

By way of a specific, non-limiting example implementation, a leading-edge detector monitors the received TD pulses 306 and generates an output signal in response to detecting a leading edge. In response to the detector output indicating detection of a leading edge, the coarse counter increments its count, and the fine counter is reset to zero and starts counting. When a total measurement timer signals the end of the measurement time the respective counts in the coarse counter and fine counter are latched for further processing. Other reference planes may be utilized than leading/rising edge of the TD pulses 306 (e.g., trailing edge, falling edges, center of pulses, without limitation) without exceeding the scope of the disclosure.

In one or more examples, the adjusted measurement time may be stored as a numerical value in a counter. The most-significant-bits (MSB) of the counter store the integer count of full round trips (an integer portion), and the least-significant-bits (LSB) of the counter store the remainder time (a fractional portion). This representation of the adjusted measurement time may be utilized to determine the average round-trip time and/or distance.

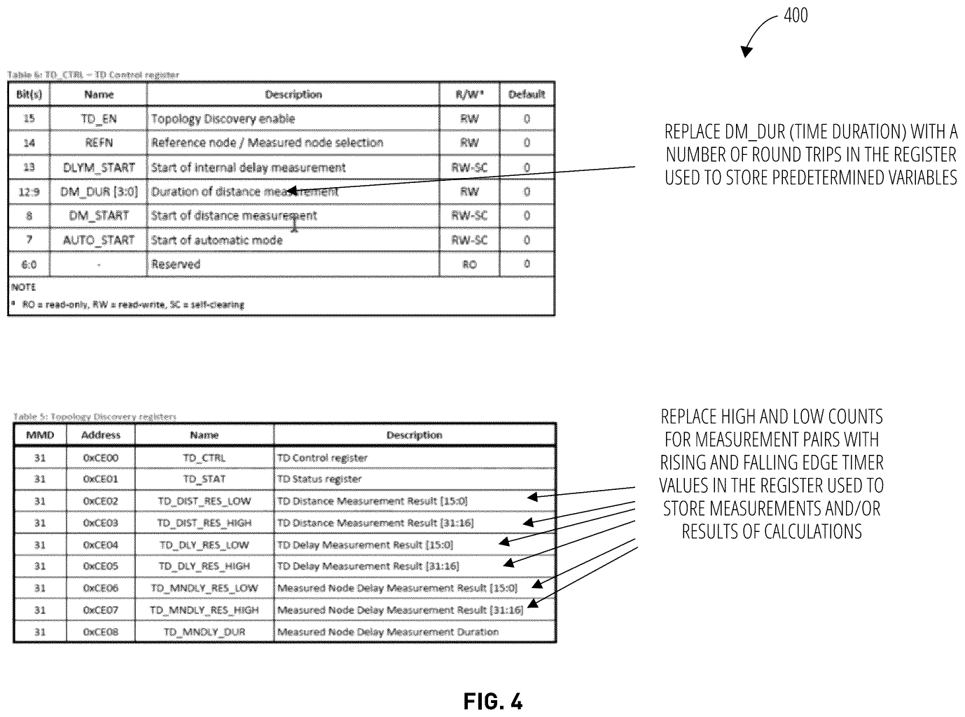

FIG. 4 is a diagram depicting changes to the TD control register and Topology Discovery Register of the OA's TC14 specification, in accordance with one or more examples.

TD control register includes fields for storing predetermined values that are used to determine, e.g., internal delay and distance, without limitation. The Topology discovery register includes fields for storing count values determined or measured during topology discovery including distance determination.

The duration of distance measurement (time duration) field in the TD control register may be replaced with the RT count field. The distance and measurement node delay measurement result fields for low (trailing) and high (leading) for storing count values may be replaced with rising edge (high) and falling edge (low) timer values and, also rising edge/falling edge fractional timer values.

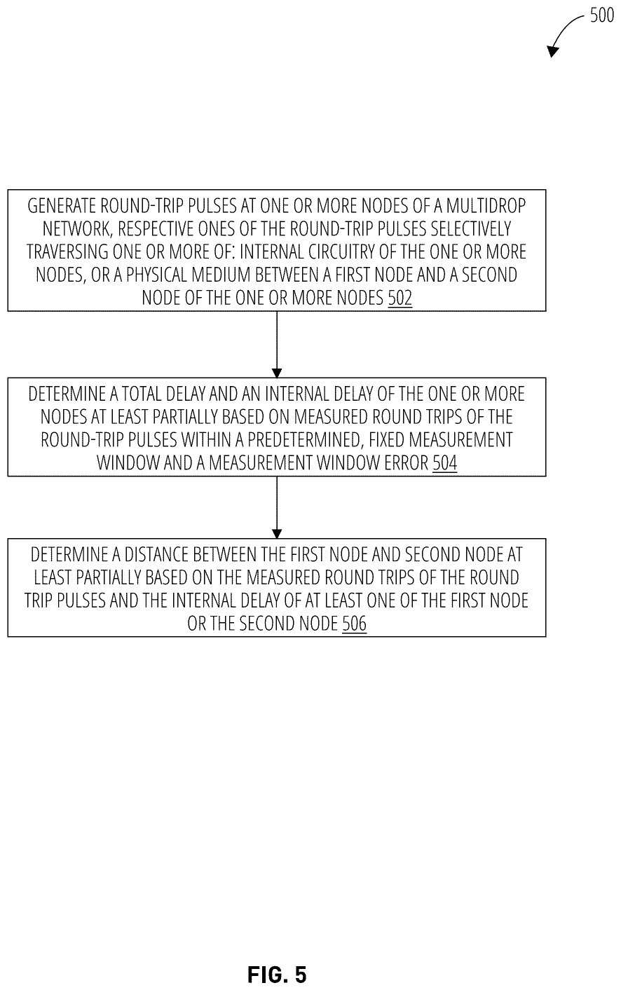

FIG. 5 illustrates an example process 500 to determine distance between a first node and a second node that are both on a multidrop network/Ethernet segment, in accordance with one or more examples. Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

According to one or more examples, the method may include generating (e.g., by a pulse generator circuit, without limitation) round-trip pulses at one or more nodes of a multidrop network, at operation 502. Respective ones of the round-trip pulses selectively traversing one or more of: internal circuitry of the one or more nodes (e.g., internal circuitry of a first node, or internal circuitry of a first node and internal circuitry of a second node, without limitation), or a physical medium between a first node and a second node of the one or more nodes (e.g., respective internal circuitry of a first node and a second node, and a cable and any intermediate devices along a signal path between the first node and the second node, without limitation). Some pulses only traverse internal circuitry of nodes (selectively traverse an internal circuitry of a node), and some pulses may traverse internal circuitry of nodes the physical medium (selectively traverse respective internal circuitry of first and second nodes and a physical medium).

To measure the total round trip, one or more pulses of the round-trip pulses may be sent from a node (either the first node or second node acting as a reference node) through the node's internal path that traverses its internal circuitry and then out over a physical medium (e.g., a physical medium segment, without limitation) to a remote node (the other one of the first node or the second node acting as a measured node). The remote node, upon receiving these pulses, echoes the pulses back through the remote node's internal path that traverses its internal circuitry and across the same physical medium (e.g., the same physical medium segment, without limitation), ultimately returning it to the reference node's receiver interface.

To measure internal delay of a node (e.g., the first node or the second node, without limitation), one or more of the round-trip pulses may be sent into a node's interface pin and the node echoes back these round-trip pulses inside the node traversing a small internal loop, rather than sending these pulses across the physical medium to a remote node—i.e., these round-trip pulses do not traverse the cable.

According to one or more examples, the method may include determining a total delay and an internal delay of least one of the first node or the second node, at operation 504. Both the total delay and the internal delay may be determined at least partially based on measured round trips of the round-trip pulses within a predetermined measurement window and a measurement window error (determined as discussed herein). In one or more examples, determining internal delay of a node may include receiving a value indicative of internal delay from another node (e.g., a reference node, as discussed above).

In one or more examples, a predetermined measurement window is set up. The measurement window may be, as non-limiting examples, a predetermined, fixed measurement window such as a fixed time duration or a fixed number of pulses, as discussed below. Alternatively, the measurement window may be an adjustable measurement window as discussed below.

Within (e.g., during, without limitation) the measurement window, process 500 specifically measures the number of pulses or the duration of time it takes when a pulse travels a measured path, such as the total path or the internal path of a node, without limitation. Measuring the round trip of the internal path of a node allows isolation of a node's internal echo delay so it (the internal delay) can be removed from the total delay to determine the delay of the physical medium.

In one or more examples, the same or different predetermined measurement windows may be utilized to measure round trips of internal circuitry of a node and to measure total round trips. For example, shorter measurement windows may be utilized with round trips to measure internal delay than with round trips to measure the full cable length.

According to one or more examples, the method may include determining a distance between the first node and second node at least partially based on the measured round trips of the round-trip pulses and the internal delay of at least one of the first node or the second node at operation 506.

The total delay (T_{Total}), the internal delay of the reference node (T_{RefNode}) and the internal delay of the measured node (T_{MeasNode}) may be utilized to determine the determine the delay of the physical medium (T_{PhysicalMedium}) according to the following expression:

$${T}_{P h y s i calMedium} = {T}_{Total} - ( {T}_{RefNode} + {T}_{MeasNode} )$$

In one or more examples, the distance may be determined based on the delay of the physical medium and a propagation delay per unit length using the following expression:

$$Distance = \frac{( {T}_{P h y s icalMedium} )}{2 x Δ}$$

Where Δ is the propagation delay per unit length in the physical medium.

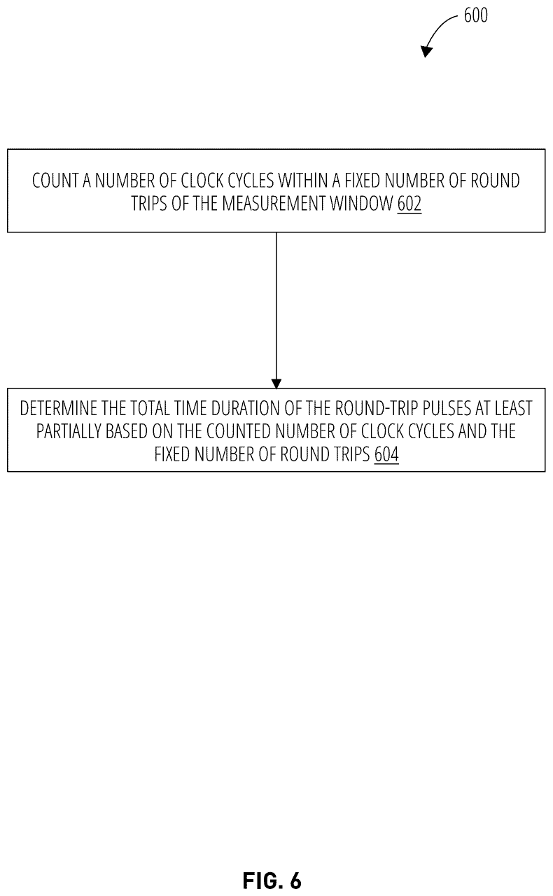

FIG. 6 illustrates an example process 600 to measure round trips of round-trip pulses when the predetermined, fixed measurement window is a fixed number of round trips (e.g., expressed as a fixed pulse count), in accordance with one or more examples. Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

Process 600 may be a sub-process or detailed method of process 500 to measure or “capture” the round trips when the predetermined, fixed measurement window is defined by a fixed number of round trips (instead of a fixed time duration).

According to one or more examples, the method may include counting a number of clock cycles within a fixed number of round trips of the measurement window at operation 602. The count measures the total elapsed time (in clock cycles) for a predetermined number N of round trips (e.g., 1100 pulses, without limitation) to complete. Knowing how many clock cycles occur while these “N” round trips happen, effectively capture the total time for those N pulses. A control register or firmware variable may hold the current count and a target number of round trips. The hardware or firmware counter starts counting clock cycles (e.g., 25 MHz clock ticks, without limitation) in response to the first round trip beginning. Upon detecting that the “Nth” round trip has completed, process 600 stops the counter and latches the final clock-cycle count. The raw clock-cycle value represents the total time for N round trips.

In one or more examples, the a lower-speed clock (e.g., 1 MHz vs. 25 MHz) may be utilized to save power compared to a higher-frequency clock used for normal operation.

According to one or more examples, the method may include determining the total time duration of the round-trip pulses at least partially based on the counted number of clock cycles and the fixed number of round trips at operation 604. Process 600 may translate that clock-cycle count (from operation 602) into a time measurement—which can then be used to derive total delay, internal delay, or distance, as the case may be. In some examples, an average round trip time may be utilized, which is the product of the clock-cycle count times clock period divided by the number N of round trips.

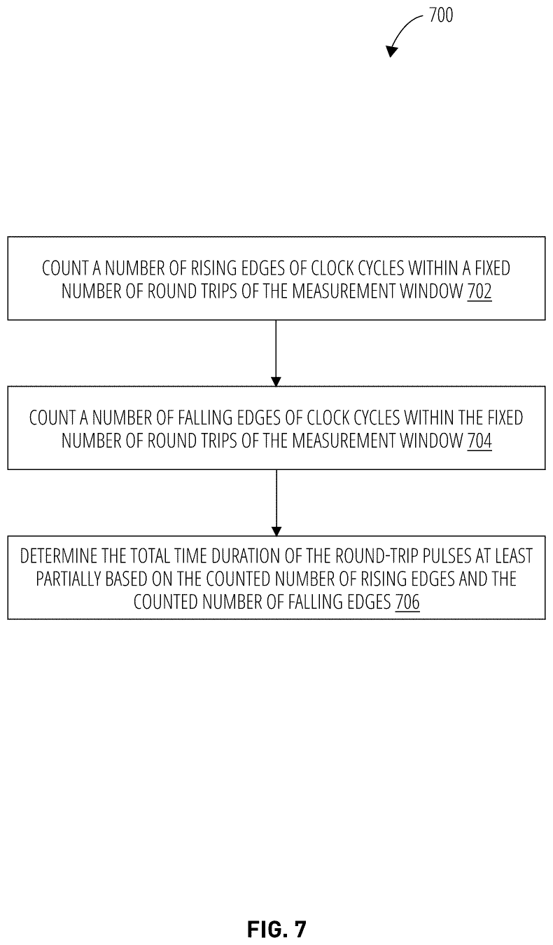

FIG. 7 illustrates an example process 700 to enhance measurement resolution by counting both rising and falling edges of a clock signal during a fixed number of round trips, in accordance with one or more examples. Although the example process 700 depicts a particular sequence of operations, the sequence may be altered without departing from the scope of the present disclosure. For example, some of the operations depicted may be performed in parallel or in a different sequence that does not materially affect the function of process 700. In other examples, different components of an example device or system that implements the process 700 may perform functions at substantially the same time or in a specific sequence.

By capturing both edges (edges of a clock) within a single clock cycle, the method obtains a more fine-grained measurement of the total time. By way of nonlimiting example, this can significantly reduce the quantization error (the difference between an actual pulse edge and the nearest sampling point) in the measurement window error.

According to one or more examples, the method may include counting a number of rising edges of clock cycles within a fixed number of round trips of the measurement window at operation 702. In one or more examples, a rising-edge counter responsive to HIGH-going transitions (LOW to HIGH) is initialized, for example, a hardware register or firmware variable is set to zero at the start of the measurement window (which begins when the first of the fixed round trips starts). A comparator or edge-detection circuit may increment the counter every time the clock transitions from LOW to HIGH. Upon completion of the Nth round trip, the rising-edge counter is stopped or latched into a register.

According to one or more examples, the method may include counting a number of falling edges of clock cycles within the fixed number of round trips of the measurement window at operation 704. In one or more examples, a falling-edge counter responsive to LOW-going transitions (HIGH to LOW) is initialized, for example, a further hardware register or further firmware variable is set to zero at the start of the measurement window (which begins when the first of the fixed round trips starts). A further edge-detection circuit (or, alternatively, the same edge detection circuit configured with two triggers: one for rising edges and one for falling edges) increments a second counter for each falling edge. Upon completion of the Nth round trips, the falling-edge counter is stopped or latched into a register.

According to one or more examples, the method may include determining the total time duration of the round-trip pulses at least partially based on the counted number of rising edges and the counted number of falling edges at operation 706. Total time may be determined by taking the sum of the count of rising edges and the count of falling edges and multiplying the sum by the dual-edge resolution (e.g., 20 nanoseconds in the case of a 25 MHz clock with a 40 nanosecond clock period, without limitation).

If a round trip begins just before the time window ends, it might only complete a portion of its travel within the window. Fully counting such a pulse (i.e., counting it as if it were entirely within the measurement window) or ignoring/discarding that fraction can introduce error in the final calculation of the average round-trip time or the total count of pulses. Process 800, discussed below, ensures those partial pulses are not lost, yielding a more precise measurement by adjusting the measured total time duration of the round-trip pulses.

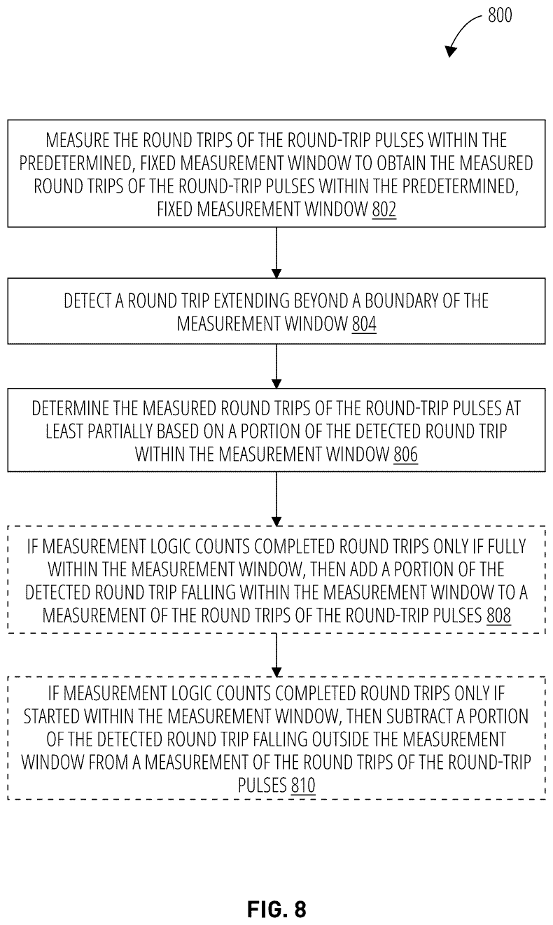

FIG. 8 illustrates an example process 800 to detect and handle partial or fractional round trips by round-trip pulses, in accordance with one or more examples. Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

By detecting a round trip that crosses the boundary of the measurement window and adding or subtracting the partial portion of that round trip, depending on the system's counting logic, process 800 ensures more accurate totals—e.g., for distance or internal delay calculations.

According to one or more examples, the method may include measuring the round trips of the round-trip pulses within the predetermined, fixed measurement window to obtain the measured round trips of the round-trip pulses within the predetermined, fixed measurement window at operation 802. Obtain the measured round trips (or a preliminary count/time) for all pulses that are at least partially contained within the measurement window. For example, a timer, clock cycle counter, or pulse counter begins when the window starts (or at the first round trip), fully completed pulses are counted or measure and partially completed pulses are noted but may need special handling (which comes in later steps), and at the end of the measurement window, the total or partial data in registers/variables is stored for further processing.

According to one or more examples, the method may include detecting a round trip extending beyond a boundary of the measurement window at operation 804. Process 800 may identify any pulse that overlaps with the boundary of the measurement window (i.e., it starts inside the window but finishes after the window closes, or vice versa). For example, check if the final pulse completion time is beyond the boundary of the measurement window (e.g., a measurement stop time, without limitation), if the final pulse finished after boundary of the measurement window, label it (e.g., apply a label to indicate it as a round trip extending beyond the boundary, without limitation), and measure or log the fraction of the round trip that occurred inside versus outside the window (e.g., via a secondary or fractional counter, without limitation).

According to one or more examples, the method may include determining the measured round trips of the round-trip pulses at least partially based on a portion of the detected round trip within the measurement window at operation 806. Incorporate (as discussed below with respect to operation 808 and operation 810) the fraction of that partial round trip into the overall measurement. Do not wholly ignore or wholly include the round trip of the final pulse—only include the fraction that belongs in the measurement window.

According to one or more examples, process 800 may optionally include: if measurement logic counts completed round trips only if fully within the measurement window, then add a portion of the detected round trip falling within the measurement window to a measurement of the round trips of the round-trip pulses at operation 808. In one or more examples, some systems may increment the “completed pulse” count only in response to the round trip being fully within the measurement window. If a pulse is partially within, then it initially gets a “0.” In that scenario, add back the portion of the round trip inside the measurement window to refine the measurement.

According to one or more examples, process 800 may optionally include: if measurement logic counts completed round trips only if started within the measurement window, then subtract a portion of the detected round trip falling outside the measurement window from a measurement of the round trips of the round-trip pulses at operation 810. In one or more examples, some systems may increment the “completed pulse” count in response to any pulse that starts in the window as “fully counted.” In that case, the counter may be overcounting if the final pulse extends partially beyond the boundary of the measurement window. In this scenario, subtract the portion of the round trip of the final pulse that is outside the measurement window.

If a round trip begins just before the time window ends, it might only complete a portion of its travel within the window. Fully counting such a pulse (i.e., counting it as if it were entirely within the measurement window) or ignoring/discarding that fraction can introduce error in the final calculation of the average round-trip time or the total count of pulses. Process 900, discussed below, ensures those partial pulses are not lost, yielding a more precise measurement, by adjusting the time duration of an adjustable measurement window.

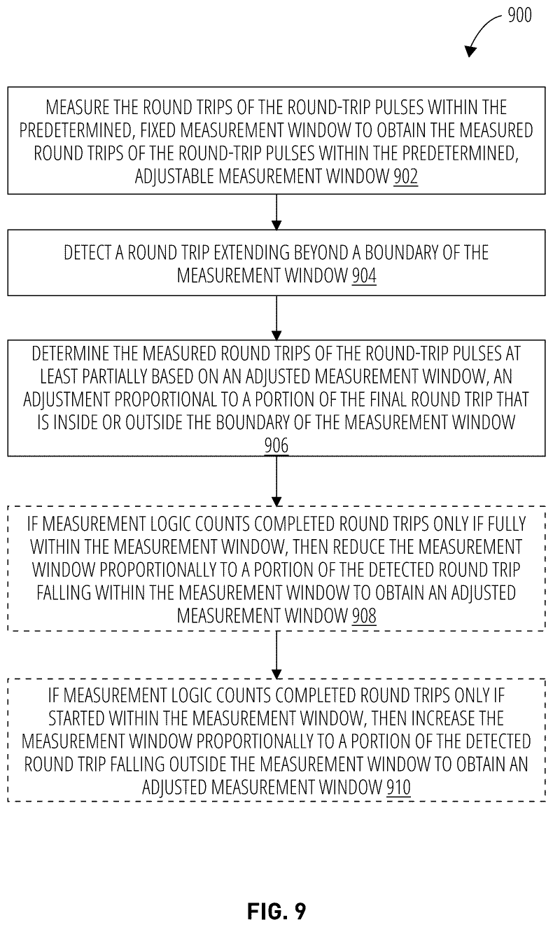

FIG. 9 illustrates an example process 900 to detect and handle partial or fractional round trips by round-trip pulses, in accordance with one or more examples. Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence.

By detecting a round trip that crosses the boundary of the measurement window and increasing the measurement window by hangover time or decreasing the measurement window by remainder time, depending on the system's counting logic, process 900 ensures more accurate totals—e.g., for distance or internal delay calculations.

According to one or more examples, the method may include measuring the round trips of the round-trip pulses within the predetermined, fixed measurement window to obtain the measured round trips of the round-trip pulses within the predetermined, fixed measurement window at operation 902. Obtain the measured round trips (or a preliminary count/time) for all pulses that are at least partially contained within the measurement window. For example, a timer, clock cycle counter, or pulse counter begins when the window starts (or at the first round trip), fully completed pulses are counted or measure and partially completed pulses are noted but may need special handling (which comes in later steps), and at the end of the measurement window, the total or partial data in registers/variables is stored for further processing.

According to one or more examples, the method may include detecting a round trip extending beyond a boundary of the measurement window at operation 904. Process 900 may identify any pulse that overlaps with the boundary of the measurement window (i.e., it starts inside the window but finishes after the window closes, or vice versa). For example, check if the final pulse completion time is beyond the boundary of the measurement window (e.g., a measurement stop time, without limitation), if the final pulse finished after boundary of the measurement window, label it (e.g., apply a label to indicate it as a round trip extending beyond the boundary, without limitation), and measure or log the fraction of the round trip that occurred inside versus outside the window (e.g., via a secondary or fractional counter, without limitation).

According to one or more examples, the method may include determining the measured round trips of the round-trip pulses at least partially based on an adjusted measurement window, at operation 906. The adjustment to the measurement window may be proportional to a portion of the final round trip that is inside or outside the boundary of the measurement window. The measurement window is adjusted to account (as discussed below with respect to operation 908 and operation 910) for that partial round trip. Pulse count is not changed. The adjusted measurement window may be used to determine measured round trips and an average round trip, as disclosed herein.

According to one or more examples, the method may include if measurement logic counts completed round trips only if fully within the measurement window, then reduce the measurement window proportionally to a portion of the detected round trip falling within the measurement window to obtain an adjusted measurement window, at operation 908. In one or more examples, some systems may increment the “completed pulse” count only in response to the round trip being fully within the measurement window. If a pulse is partially within then the it gets a “0.” In that scenario, reduce the measurement window so it ends at the last fully completed round trip, thereby excluding any partially completed pulse.

According to one or more examples, the method may include if measurement logic counts completed round trips only if started within the measurement window, then increase the measurement window proportionally to a portion of the detected round trip falling outside the measurement window to obtain an adjusted measurement window, at operation 910. In one or more examples, some systems may increment the “completed pulse” count in response to any pulse that starts in the window as “fully counted.” In that case, the counter may be overcounting if the final pulse extends partially beyond the boundary of the measurement window. In that scenario, extend the measurement window to end when the final partial pulse is fully completed, ensuring that the entire pulse is included.

If a round trip begins just before the time window ends, it might only complete a portion of its travel within the window. Ignoring that fraction can introduce error in the final calculation of the average round-trip time or the total count of pulses. Process 1000, discussed below, ensures those partial round-trips are not lost, yielding a more precise measurement.

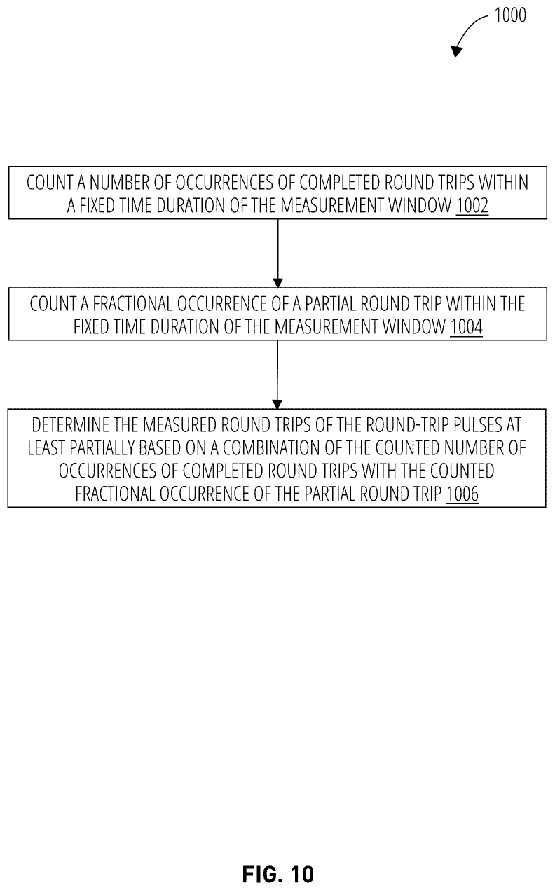

FIG. 10 illustrates an example process 1000 to measure round trips of round-trip pulses when the predetermined, fixed measurement window is a fixed time duration, in accordance with one or more examples. Although the example process 1000 depicts a particular sequence of operations, the sequence may be altered without departing from the scope of the present disclosure. For example, some of the operations depicted may be performed in parallel or in a different sequence that does not materially affect the function of the process 1000. In other examples, different components of an example device or system that implements the process 1000 may perform functions at substantially the same time or in a specific sequence.

By counting both fully completed round trips and a fractional (partial) round trips, process 1000 may improve distance or delay accuracy instead of ignoring or rounding off a partial pulse.

According to one or more examples, the method may include counting a number of occurrences of completed round trips within a fixed time duration of the measurement window at operation 1002. During the fixed time duration (the measurement window), a primary or integer counter measures (counts) how many round trips fully start and finish inside that time window. This provides an integer count of completed pulses. For example, A timer or reference clock starts at the beginning of the fixed time duration. Every time the system detects the end of a round trip (i.e., the echo pulse returns), it checks if the clock is still within the fixed time duration. Upon expiration of the fixed time duration, the final integer count N of fully completed round trips may be stored.

According to one or more examples, the method may include counting a fractional occurrence of a partial round trip within the fixed time duration of the measurement window at operation 1004. Some round trips may not be fully complete before expiration of the fixed time duration. Rather than discard that partial pulse, measure how much of it actually occurred inside the window or outside of the window (e.g., 40% or 0.4 of a round trip, without limitation) depending on the design implementation.

For example, when the time window ends, a pulse might be “in flight” (it started before the window ended but did not finish until after the window ended). The system sees that the “end” of that pulse arrives after the window boundary, so it is only partially within the time window. A secondary or fractional counter can measure (e.g., count in fractional increments of the primary counter, without limitation) how many clock cycles (or how many ns) of that last pulse were inside the fixed time duration of the measurement window. The fractional value may be stored (e.g., 0, 0.2, 0.4, 0.5, 0.7 without limitation) in a register or variable, which indicates a partial round trip.

According to one or more examples, the method may include determining the measured round trips of the round-trip pulses at least partially based on a combination of the counted number of occurrences of completed round trips with the counted fractional occurrence of the partial round trip at operation 1006. If N is the number of fully completed round trips, and F is the fraction of the partially completed pulse (e.g., 0.4), your final “effective” count is N+F. In one or more examples, that final effective pulse count into an average round trip per unit time or a total count for the fixed time duration measurement window.

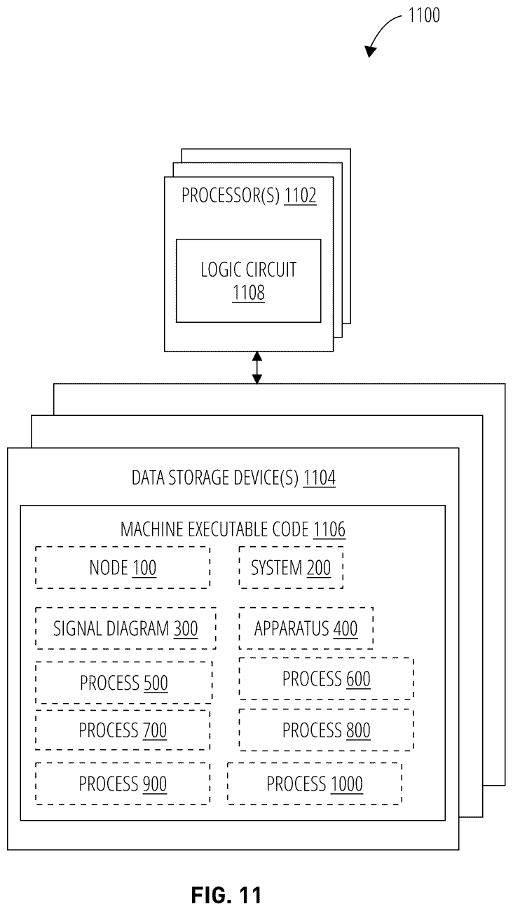

It will be appreciated by those of ordinary skill in the art that functional elements of examples disclosed herein (e.g., functions, operations, acts, processes, or methods) may be implemented in any suitable hardware, software, firmware, or combinations thereof. FIG. 11 illustrates non-limiting examples of implementations of functional elements disclosed herein. In some examples, some or all portions of the functional elements disclosed herein may be performed by hardware capable of carrying out the functional elements.

FIG. 11 is a block diagram of a circuitry 1100 that, in some examples, may be used to implement various functions, operations, acts, processes, or methods disclosed herein. The circuitry 1100 includes one or more processors 1102 (sometimes referred to herein as “processors 1102”) operably coupled to one or more data storage devices 1104 (sometimes referred to herein as “storage 1104”). The storage 1104 includes machine executable code 1106 stored thereon and the processors 1102 include logic circuit 1108. The machine executable code 1106 includes information describing functional elements that may be implemented by (e.g., performed by) the logic circuit 1108. The logic circuit 1108 is adapted to implement (e.g., perform) the functional elements described by the machine executable code 1106. The circuitry 1100, when executing the functional elements described by the machine executable code 1106, should be considered as special purpose hardware for carrying out functional elements disclosed herein. In one or more examples, the processors 1102 may perform the functional elements described by the machine executable code 1106 sequentially, concurrently (e.g., on one or more different hardware platforms), or in one or more parallel process streams.

When implemented by logic circuit 1108 of the processors 1102, the machine executable code 1106 adapts the processors 1102 to perform operations of examples disclosed herein. By way of non-limiting example, the machine executable code 1106 may adapt the processors 1102 to perform some or a totality of operations of one or more of processes to measure distance between nodes in a multidrop network discussed herein, including process 500, process 600, process 700, process 800, process 900, and process 1000, and the process of signal diagram 300.

Also by way of non-limiting example, the machine executable code 1106 may adapt the processors 1102 to perform some or a totality of features, functions, or operations disclosed herein for one or more of: internal circuit 102, transmitter 104, receiver 106, connection 108, measurement circuit 114, logic circuit 116, pulse generator circuit 118, and physical medium portion 120 of node 100; reference node 202, measured node 204, and physical medium 206 of system 200; and apparatus 400.

The processors 1102 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device (PLD), discrete gate or transistor logic, discrete hardware components, other programmable device, or any combination thereof designed to perform the functions disclosed herein. A general-purpose computer including one or more processors 1102, including a general-purpose processor, is considered a special-purpose computer at least while the general-purpose computer executes functional elements corresponding to the machine executable code 1106 (e.g., software code, firmware code, configuration data, hardware descriptions, without limitation) related to examples of the present disclosure. It is noted that a general-purpose processor (which may also be referred to herein as a host processor or simply a host) may be a microprocessor, but in the alternative, a general-purpose processor of processors 1102 may include any conventional processor, controller, microcontroller, or state-machine. An FPGA or other PLD of the processors 1102 may be configured (e.g., programmed, without limitation) with configuration data to perform functions disclosed herein, or, additionally or alternatively, may be capable of being configured or re-configured (e.g., programmable, or re-programmable, without limitation) with configuration data to perform functions disclosed herein. The processors 1102 may also be implemented as a combination of computing devices, such as a combination of a DSP and a microprocessor, a plurality of microprocessors, one or more microprocessors in conjunction with a DSP core, or any other such configuration.

In one or more examples, the storage 1104 includes volatile data storage (e.g., random-access memory (RAM), static RAM (SRAM), without limitation), and non-volatile data storage (e.g., Flash memory, a hard disc drive, a solid-state drive, erasable programmable read-only memory (EPROM), without limitation). In some examples, the processors 1102 and the storage 1104 may be implemented into a single device (e.g., a semiconductor device product, a system on chip (SOC), without limitation). In some examples, the processors 1102 and the storage 1104 may be implemented into separate devices.

In one or more examples, the machine executable code 1106 may include computer-readable instructions (e.g., software code, firmware code). By way of non-limiting example, the computer-readable instructions may be stored by the storage 1104, accessed directly by the processors 1102, and executed by the processors 1102 using at least the logic circuit 1108. Also by way of non-limiting example, the computer-readable instructions may be stored on the storage 1104, transferred to a memory device (not shown) for execution, and executed by the processors 1102 using at least the logic circuit 1108. Processors 1102 or logic circuit 1108 thereof may be coupled to such a memory device or include such a memory device (e.g., a configuration memory cell, without limitation). Accordingly, in some examples, the logic circuit 1108 includes electrically configurable logic circuit 1108.

In one or more examples, the machine executable code 1106 may describe hardware (e.g., circuitry) to be implemented in the logic circuit 1108 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG®, SYSTEMVERILOG™ or very-large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1108 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine executable code 1106 may include an HDL, an RTL, a GL description, a mask level description, other hardware description, or any combination thereof.

In examples where the machine executable code 1106 includes a hardware description (at any level of abstraction), a system (not shown, but including the storage 1104) implements the hardware description described by the machine executable code 1106. By way of non-limiting example, the processors 1102 may include a programmable logic device (e.g., an FPGA or a PLC, without limitation) and the logic circuit 1108 may be electrically controlled (e.g., via configuration data, without limitation) to implement circuitry corresponding to the hardware description into the logic circuit 1108. Also, by way of non-limiting example, the logic circuit 1108 may include hard-wired logic manufactured by a manufacturing system (not shown but including the storage 1104) according to the hardware description of the machine executable code 1106.

Regardless of whether the machine executable code 1106 includes computer-readable instructions or a hardware description, the logic circuit 1108 is adapted to perform the functional elements described by the machine executable code 1106 when implementing the functional elements of the machine executable code 1106. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A method, comprising: generating round-trip pulses at one or more nodes of a multidrop network, respective ones of the round-trip pulses selectively traversing one or more of: internal circuitry of the one or more nodes, or a physical medium between a first node and a second node of the one or more nodes; determining a total delay and an internal delay of the one or more nodes at least partially based on: measured round trips of the round-trip pulses within a predetermined measurement window; and a measurement window error; and determining a distance between the first node and second node at least partially based on the measured round trips of the round-trip pulses and the internal delay of at least one of the first node or the second node.

Example 2: The method according to Example 1, wherein the predetermined measurement window is indicative of either: a fixed time duration, or a fixed number of round trips.

Example 3: The method according to Examples 1 and 2, comprising measuring the round trips of the round-trip pulses within a predetermined, fixed measurement window to obtain the measured round trips of the round-trip pulses within the predetermined measurement window.

Example 4: The method according to any of Examples 1 to 3, wherein measuring the round trips of the round-trip pulses within the predetermined, fixed measurement window comprises: counting a number of clock cycles within a fixed number of round trips of the measurement window; and determining the measured round trips of the round-trip pulses at least partially based on the counted number of clock cycles.

Example 5: The method according to any of Examples 1 to 4, wherein measuring the round trips of the round-trip pulses within the predetermined, fixed measurement window comprises: counting a number of rising edges of clock cycles within a fixed number of round trips of the measurement window; counting a number of falling edges of clock cycles within the fixed number of round trips of the measurement window; and determining the measured round trips of the round-trip pulses at least partially based on the counted number of rising edges and the counted number of falling edges.

Example 6: The method according to any of Examples 1 to 5, wherein measuring the round trips of the round-trip pulses within the predetermined, fixed measurement window comprises: counting a number of occurrences of completed round trips within a fixed time duration of the measurement window; counting a fractional occurrence of a partial round trip within the fixed time duration of the measurement window; and determining the measured round trips of the round-trip pulses at last partially based on a combination of the counted number of occurrences of completed round trips with the counted fractional occurrence of the partial round trip.

Example 7: The method according to any of Examples 1 to 6, wherein measuring the round trips of the round-trip pulses within the predetermined, fixed measurement window comprises: counting a number of round-trip pulses, wherein respective counts of the counted number of round-trip pulses are triggered at least partially responsive to leading edges of the round-trip pulses; counting a number of clock cycles until the counted number of round-trip pulses is equal to a predetermined, fixed number of round trips of the measurement window; counting a number of clock cycles until a final round-trip pulse of the counted number of round-trip pulses completes; and determining the measured round trips of the round-trip pulses at least partially based on a combination of the counted number of clock cycles until the counted number of round-trip pulses is equal to a predetermined, fixed number of round trips and the counted number of clock cycles until the final round-trip pulse of the counted number of round-trip pulses completes.

Example 8: The method according to any of Examples 1 to 7, wherein measuring the round trips of the round-trip pulses within the predetermined, fixed measurement window comprises: detecting a round trip extending beyond a boundary of the measurement window; and determining the measured round trips of the round-trip pulses at least partially based on a portion of the detected round trip within the measurement window.

Example 9: The method according to any of Examples 1 to 8, wherein determining the measured round trips of the round-trip pulses at least partially based on the portion of the detected round trip within the measurement window comprises: adding a portion of the detected round trip falling within the measurement window to a measurement of the round trips of the round-trip pulses.

Example 10: The method according to any of Examples 1 to 9, wherein determining the measured round trips of the round-trip pulses at least partially based on the portion of the detected round trip within the measurement window comprises: subtracting a portion of the detected round trip falling outside the measurement window from a measurement of the round trips of the round-trip pulses.

Example 11: The method according to any of Examples 1 to 10, comprising measuring the round trips of the round-trip pulses within a predetermined, adjustable measurement window to obtain the measured round trips of the round-trip pulses within the predetermined measurement window.

Example 12: The method according to any of Examples 1 to 11, wherein measuring the round trips of the round-trip pulses within the predetermined, adjustable measurement window comprises: detecting a round trip extending beyond a boundary of the measurement window; and determining the measured round trips of the round-trip pulses at least partially based on an adjusted measurement window, an adjustment proportional to a portion of a final round trip that is inside or outside the boundary of the measurement window.

Example 13: An apparatus, comprising: a pulse generator circuit to generate round-trip pulses at one or more nodes of a multidrop network, respective ones of the round-trip pulses selectively traversing one or more of: internal circuitry of the one or more nodes or a physical medium between a first node and a second node of the one or more nodes; a measurement circuit to measure, within a predetermined measurement window, round trips of the round-trip pulses generated by the pulse generator circuit and to provide measurement data indicative of measured round trips of the round-trip pulses; and a logic circuit to: determine a total delay and an internal delay of at least one of the one or more nodes based at least partially on: the measurement data; and a measurement window error; and determine a distance between the first node and the second node at least partially based on the measurement data and the determined internal delay of at least one of the first node or the second node.

Example 14: The apparatus according to Example 13, wherein the predetermined measurement window is associated with either a fixed time duration or a fixed number of round trips.

Example 15: The apparatus according to Examples 13 and 14, wherein the measurement circuit to obtain the measured round trips of the round-trip pulses within the predetermined measurement window by capturing at least one timing or counting signal indicative of the round-trip pulses.

Example 16: The apparatus according to any of Examples 13 to 15, wherein the measurement circuit to count a number of clock cycles within a fixed number of round trips of the measurement window, and wherein the logic circuit is configured to determine the measured round trips of the round-trip pulses at least partially based on the counted number of clock cycles.

Example 17: The apparatus according to any of Examples 13 to 16, wherein the measurement circuit to: count a number of rising edges of clock cycles within a fixed number of round trips; count a number of falling edges of clock cycles within the fixed number of round trips; and determine the measured round trips of the round-trip pulses at least partially based on the counted rising edges and falling edges.

Example 18: The apparatus according to any of Examples 13 to 17, wherein the measurement circuit to: count occurrences of completed round trips within a fixed time duration; count a fractional occurrence of a partial round trip within the fixed time duration; and determine the measured round trips of the round-trip pulses at least partially based on a combination of the counted occurrences of completed round trips with the fractional occurrence of the partial round trip.

Example 19: The apparatus according to any of Examples 13 to 18, wherein the measurement circuit to: count a number of round-trip pulses in response to leading edges of said pulses until the counted number of round-trip pulses equals a predetermined, fixed number; count a number of clock cycles until a final round-trip pulse of said counted number completes; and determine the measured round trips of the round-trip pulses at least partially based on the counted number of clock cycles until the predetermined number of pulses is reached and the counted number of clock cycles until the final round-trip pulse completes.

Example 20: The apparatus according to any of Examples 13 to 19, wherein the measurement circuit to detect at least one round trip extending beyond a boundary of the measurement window, and wherein the measurement circuit to adjust the measurement data to account for a portion of said round trip that lies within the measurement window.

Example 21: The apparatus according to any of Examples 13 to 20, wherein a processing circuit to add a portion of the detected round trip falling within the measurement window to the measurement data.

Example 22: The apparatus according to any of Examples 13 to 21, wherein a processing circuit to subtract a portion of the detected round trip that falls outside the measurement window from the measurement data.

Example 23: The apparatus according to any of Examples 13 to 22, wherein the measurement circuit to measure the round trips of the round-trip pulses within a predetermined, adjustable measurement window, and wherein the measurement circuit to detect at least one round trip extending beyond a boundary of the measurement window, and provide adjusted measurement data based on at least a portion of the detected round trip.

Example 24: The apparatus according to any of Examples 13 to 23, wherein the logic circuit is to reduce the measurement window in proportion to a portion of a final round trip that falls within the boundary, such that the adjusted measurement window ends at a time corresponding to the last fully completed round trip.

Example 25: The apparatus according to any of Examples 13 to 24, wherein the logic circuit to increase the measurement window in proportion to a portion of a final round trip that extends beyond the boundary, such that the adjusted measurement window ends upon completion of the detected round trip.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
generating round-trip pulses at one or more nodes of a multidrop network, respective ones of the round-trip pulses selectively traversing one or more of: internal circuitry of the one or more nodes, or a physical medium between a first node and a second node of the one or more nodes;
determining a total delay and an internal delay of the one or more nodes at least partially based on:
measured round trips of the round-trip pulses within a predetermined measurement window; and
a measurement window error; and
determining a distance between the first node and second node at least partially based on the measured round trips of the round-trip pulse, and the internal delay of at least one of the first node or the second node.

2. The method of claim 1, wherein the predetermined measurement window is indicative of either: a fixed time duration, or a fixed number of round trips.

3. The method of claim 1, comprising measuring the round trips of the round-trip pulses within a predetermined, fixed measurement window to obtain the measured round trips of the round-trip pulses within the predetermined measurement window.

4. The method of claim 3, wherein measuring the round trips of the round-trip pulses within the predetermined, fixed measurement window comprises:
counting a number of clock cycles within a fixed number of round trips of the measurement window; and
determining the measured round trips of the round-trip pulses at least partially based on the counted number of clock cycles.

5. The method of claim 3, wherein measuring the round trips of the round-trip pulses within the predetermined, fixed measurement window comprises:
counting a number of rising edges of clock cycles within a fixed number of round trips of the measurement window;
counting a number of falling edges of clock cycles within the fixed number of round trips of the measurement window; and
determining the measured round trips of the round-trip pulses at least partially based on the counted number of rising edges and the counted number of falling edges.

6. The method of claim 3, wherein measuring the round trips of the round-trip pulses within the predetermined, fixed measurement window comprises:
counting a number of occurrences of completed round trips within a fixed time duration of the measurement window;
counting a fractional occurrence of a partial round trip within the fixed time duration of the measurement window; and
determining the measured round trips of the round-trip pulses at last partially based on a combination of the counted number of occurrences of completed round trips with the counted fractional occurrence of the partial round trip.

7. The method of claim 4, wherein measuring the round trips of the round-trip pulses within the predetermined, fixed measurement window comprises:
counting a number of round-trip pulses, wherein respective counts of the counted number of round-trip pulses are triggered at least partially responsive to leading edges of the round-trip pulses;
counting a number of clock cycles until the counted number of round-trip pulses is equal to a predetermined, fixed number of round trips of the measurement window;
counting a number of clock cycles until a final round-trip pulse of the counted number of round-trip pulses completes; and
determining the measured round trips of the round-trip pulses at least partially based on a combination of the counted number of clock cycles until the counted number of round-trip pulses is equal to a predetermined, fixed number of round trips and the counted number of clock cycles until the final round-trip pulse of the counted number of round-trip pulses completes.

8. The method of claim 3, wherein measuring the round trips of the round-trip pulses within the predetermined, fixed measurement window comprises:
detecting a round trip extending beyond a boundary of the measurement window; and
determining the measured round trips of the round-trip pulses at least partially based on a portion of the detected round trip within the measurement window.

9. The method of claim 8, wherein determining the measured round trips of the round-trip pulses at least partially based on the portion of the detected round trip within the measurement window comprises:
adding a portion of the detected round trip falling within the measurement window to a measurement of the round trips of the round-trip pulses.

10. The method of claim 8, wherein determining the measured round trips of the round-trip pulses at least partially based on the portion of the detected round trip within the measurement window comprises:
subtracting a portion of the detected round trip falling outside the measurement window from a measurement of the round trips of the round-trip pulses.

11. The method of claim 1, comprising measuring the round trips of the round-trip pulses within a predetermined, adjustable measurement window to obtain the measured round trips of the round-trip pulses within the predetermined measurement window.

12. The method of claim 11, wherein measuring the round trips of the round-trip pulses within the predetermined, adjustable measurement window comprises:
detecting a round trip extending beyond a boundary of the measurement window; and
determining the measured round trips of the round-trip pulses at least partially based on an adjusted measurement window, an adjustment proportional to a portion of a final round trip that is inside or outside the boundary of the measurement window.

13. An apparatus, comprising:
a pulse generator circuit to generate round-trip pulses at one or more nodes of a multidrop network, respective ones of the round-trip pulses selectively traversing one or more of: internal circuitry of the one or more nodes or a physical medium between a first node and a second node of the one or more nodes;
a measurement circuit to measure, within a predetermined measurement window, round trips of the round-trip pulses generated by the pulse generator circuit and to provide measurement data indicative of measured round trips of the round-trip pulses; and
a logic circuit to:
determine a total delay and an internal delay of at least one of the one or more nodes based at least partially on:
the measurement data; and
a measurement window error; and
determine a distance between the first node and the second node at least partially based on the measurement data and the determined internal delay of at least one of the first node or the second node.

14. The apparatus of claim 13, wherein the predetermined measurement window is associated with either a fixed time duration or a fixed number of round trips.

15. The apparatus of claim 13, wherein the measurement circuit to obtain the measured round trips of the round-trip pulses within the predetermined measurement window by capturing at least one timing or counting signal indicative of the round-trip pulses.

16. The apparatus of claim 15, wherein the measurement circuit to count a number of clock cycles within a fixed number of round trips of the measurement window, and wherein the logic circuit is configured to determine the measured round trips of the round-trip pulses at least partially based on the counted number of clock cycles.

17. The apparatus of claim 15, wherein the measurement circuit to:
count a number of rising edges of clock cycles within a fixed number of round trips;
count a number of falling edges of clock cycles within the fixed number of round trips; and
determine the measured round trips of the round-trip pulses at least partially based on the counted rising edges and falling edges.

18. The apparatus of claim 15, wherein the measurement circuit to:
count occurrences of completed round trips within a fixed time duration;
count a fractional occurrence of a partial round trip within the fixed time duration; and
determine the measured round trips of the round-trip pulses at least partially based on a combination of the counted occurrences of completed round trips with the fractional occurrence of the partial round trip.

19. The apparatus of claim 15, wherein the measurement circuit to:
count a number of round-trip pulses in response to leading edges of said pulses until the counted number of round-trip pulses equals a predetermined, fixed number;
count a number of clock cycles until a final round-trip pulse of said counted number completes; and
determine the measured round trips of the round-trip pulses at least partially based on the counted number of clock cycles until the predetermined number of pulses is reached and the counted number of clock cycles until the final round-trip pulse completes.

20. The apparatus of claim 15, wherein the measurement circuit to detect at least one round trip extending beyond a boundary of the measurement window, and wherein the measurement circuit to adjust the measurement data to account for a portion of said round trip that lies within the measurement window.

21. The apparatus of claim 20, wherein a processing circuit to add a portion of the detected round trip falling within the measurement window to the measurement data.

22. The apparatus of claim 20, wherein a processing circuit to subtract a portion of the detected round trip that falls outside the measurement window from the measurement data.

23. The apparatus of claim 13, wherein the measurement circuit to measure the round trips of the round-trip pulses within a predetermined, adjustable measurement window, and wherein the measurement circuit to detect at least one round trip extending beyond a boundary of the measurement window, and provide adjusted measurement data based on at least a portion of the detected round trip.

24. The apparatus of claim 23, wherein the logic circuit is to reduce the measurement window in proportion to a portion of a final round trip that falls within the boundary, such that the adjusted measurement window ends at a time corresponding to the last fully completed round trip.

25. The apparatus of claim 23, wherein the logic circuit to increase the measurement window in proportion to a portion of a final round trip that extends beyond the boundary, such that the adjusted measurement window ends upon completion of the detected round trip.
